(19) United States
(12) Patent Application Publication
(10) Pub. No.: US 2022/0156850 A1
(43) Pub. Date: May 19, 2022

(54) SYSTEM AND METHOD FOR BILL PAYMENT DIRECTLY FROM PAYROLL SYSTEM

(71) Applicant: AISE LLC, Clawson, MI (US)

(72) Inventor: Patrick Tully, Clawson, MI (US)

(21) Appl. No.: 17/524,089

(22) Filed: Nov. 11, 2021

Related U.S. Application Data
(60) Provisional application No. 63/115,265, filed on Nov. 18, 2020.

(51) Int. Cl. G06Q 40/00; G06Q 40/02; G06Q 20/10; G06N 3/02

(52) U.S. Cl. CPC G06Q 40/125; G06N 3/02; G06Q 20/102; G06Q 40/02

(57) ABSTRACT

This disclosure relates to a system and method for bill payment from a payroll system. In particular, this disclosure enables employees to effectively pay their bills directly from their employer's payroll system, which has a number of benefits including providing employees with a clearer understanding of their discretionary income and, in turn, provides employees with benefits to their overall physical and mental health. This disclosure also provides increased certainty to third party billers, knowing their bills will be paid from a relatively secure source, namely the employer's payroll system.

### RELATED APPLICATIONS

This application claims the benefit of U.S. Provisional Application No. 63/115,265, filed Nov. 18, 2020, the entirety of which is herein incorporated by reference.

### TECHNICAL FIELD

This disclosure relates to a system and method for bill payment from a payroll system.

### BACKGROUND

Payroll plays a major role in the operations of an organization. From the perspective of the organization, a payroll is a list of the employees of the organization entitled to receive pay as well as other benefits during a payroll period. From the perspective of the employees, payroll is often their sole or significant source of income. Employees are paid via the payroll system of an organization via a paycheck after each payroll period. Employees have become accustomed in recent years to receiving electronic paychecks, which are often accompanied by an electronic paystub. In such systems, the employee's paycheck is directly deposited into their bank account(s) of choice, and the electronic paystub is provided to the employee. The electronic paystub provides notice to the employee of the electronic deposit amount as well as any deductions for taxes, healthcare, retirement, etc., that occurred during the payroll period. Employees have grown increasingly accustomed to the automated nature of current payroll systems.

### SUMMARY

A method according to an exemplary aspect of the present disclosure includes, among other things, paying a bill owed by an employee to a third party biller using a payroll system of an organization by first directing funds from the payroll system to a secondary account of the employee and then directing funds from the secondary account to the third party biller.

In a further embodiment, the method includes permitting the employee to select when the paying step occurs within a billing cycle, and wherein the paying step occurs at a time corresponding to the selection of the employee.

In a further embodiment, the permitting step includes permitting the employee to select to make a full payment of the bill during a first period in the billing cycle, a full payment of the bill during a second period in the billing cycle, or a partial payment of the bill during the first period and a partial payment of the bill during the second period in the billing cycle.

In a further embodiment, the permitting step includes presenting the employee with an interface on a computing device of the employee. Further, the interface includes inputs for the employee to make the selection.

In a further embodiment, the paying step includes paying a plurality of bills of the employee from the payroll system.

In a further embodiment, the method includes presenting the employee with a discretionary income figure, wherein the discretionary income figure is a base pay of the employee less traditional withholdings and less the plurality of bills.

In a further embodiment, the secondary account is used solely for completing the paying step and is not a primary account of the employee.

In a further embodiment, the method includes, using a neural network, suggesting that the employee pay another bill using the payroll system.

In a further embodiment, the payroll system communicates with a software application configured to at least partially perform the paying step.

In a further embodiment, the software application is a plug-in for payroll software.

In a further embodiment, the third party biller is a personal savings account of the employee.

In a further embodiment, the method includes providing the employee with a reward for completing the paying step.

In a further embodiment, the reward is interest accumulated in the secondary account.

In a further embodiment, the bill is owed by a first employee and a second employee to the third party biller, first funds are directed from the payroll system to the secondary account on behalf of the first employee, second funds are directed from the payroll system to the secondary account on behalf of the second employee, and the combined first and second funds are directed from the secondary account to the third party biller.

In a further embodiment, the method includes using a neural network to issue a warning to the employee if the employee is seeking to pay a bill that, in the determination of the neural network, will have an adverse influence on the physical, mental, or financial health of the employee.

In a further embodiment, the method includes anonymously comparing the employee to similarly-situated users and disclosing the results of the comparison to the employee.

In a further embodiment, the secondary account is requested to be created by a software application when the employee initially begins using the payroll system to pay third party bills.

A system according to an exemplary aspect of the present disclosure includes, among other things, an application configured to run on a computing device and configured to cause the computing device to direct funds from a payroll system of an organization to pay a bill of an employee owed to a third party. The funds are directed to the third party via a secondary account of the employee.

In a further embodiment, the application is configured to permit the employee to select when the funds are directed within a billing cycle.

In a further embodiment, the secondary account is used solely for completing the paying step and is not a primary account of the employee.

### BRIEF DESCRIPTION OF THE DRAWINGS

FIG. 1 is a highly schematic view of an example system according to this disclosure.

FIG. 2 is schematic representation of an example relationship between an existing payroll system, an application, employees, and billers.

FIG. 3 is an example interface of the application.

FIG. 4 is another example interface of the application.

### DETAILED DESCRIPTION

This disclosure relates to a system and method for bill payment from a payroll system. In particular, this disclosure enables employees to effectively pay their bills directly from their employer's payroll system, which has a number of benefits including providing employees with a clearer understanding of their discretionary income and, in turn, provides employees with benefits to their overall physical and mental health. This disclosure also provides increased certainty to third party billers, knowing their bills will be paid from a relatively secure source, namely the employer's payroll system.

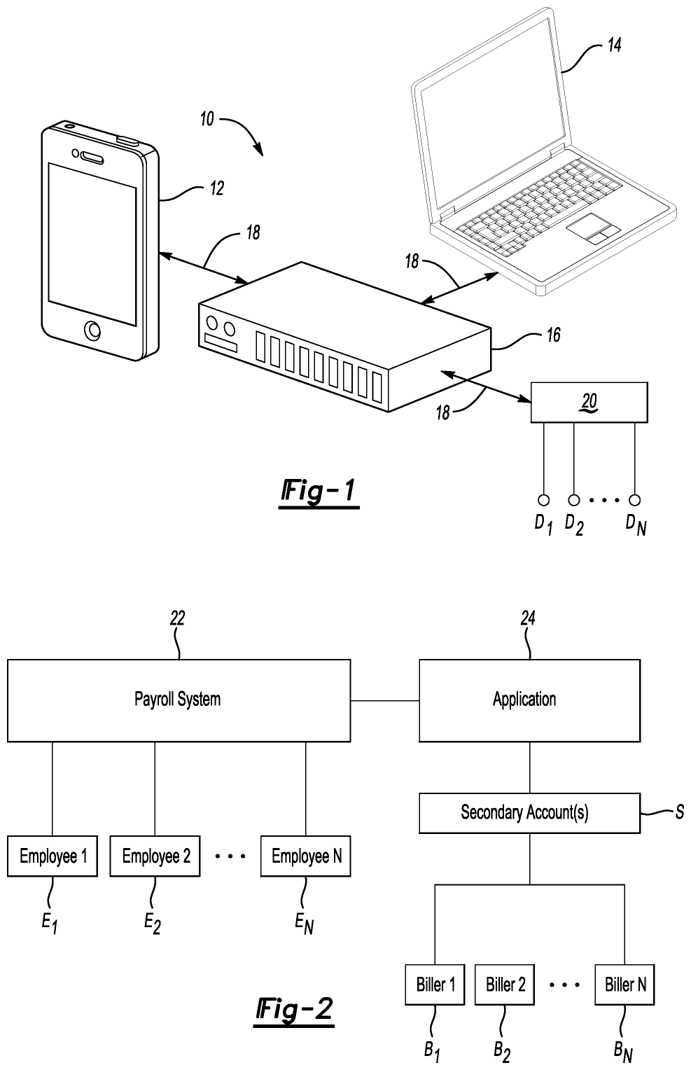

FIG. 1 is a highly schematic view of an example system 10 for paying bills from a payroll system. In this example, the system 10 includes a first computing device 12, a second computing device 14, and a third computing device 16. As shown in FIG. 1, the first computing device 12 is a mobile computing device, such as a tablet or a smartphone. The second computing device 14 is a laptop or desktop computer, and the third computing device 16 is a computing device including a server. Relative to the third computing device 16 in particular, while shown as a single server, the third computing device 16 can be implemented using multiple components at various locations. The first, second, and third computing devices 12, 14, 16 are illustrated for purposes of explanation, and should not be considered as limiting regarding the type or number of computing devices used with the disclosed system 10.

In this example, the first, second, and third computing devices 12, 14, 16 are in communication with one other as schematically shown via connections 18, which include wireless links and/or hard-wired connections, such as those used to access the Internet. Each of the first, second, and third computing devices 12, 14, 16 may include memory, hardware, and software, and be configured to communicate with one another and transmit data between one another. The first, second, and third computing devices 12, 14, 16 may further be configured to store information and data, and send and receive instructions to one another to execute the methodology and techniques described below.

The system 10 may also include an artificial neural network 20 (“neural network 20”) incorporated into or interfaced with the system 10. Alternatively or in addition, the neural network 20 may be embodied in whole or in part on a cloud based service. The neural network 20 is configured to receive and process a plurality of different types of data D₁-D_{N}, where “N” represents any number. The neural network 20 may be a deep generative neural network, which is alternatively referred to as a flow model neural network. The neural network 20 provides a framework for machine learning. Specifically, in one example, the neural network 20 is trained to predict how various data inputs (i.e., from the data D₁-D_{N}) relate to whether an employee should incur a new financial obligation. Other example uses for the neural network 20 are described below. A neural network 20 is not required in all examples.

FIG. 2 schematically illustrates an example relationship between a payroll system 22 of an organization, employees E₁-E_{N} of the organization, and third-party billers B₁-B_{N}. Relative to the employees E₁-E_{N} and billers B₁-E_{N}, “N” represents any number. Further, the term “organization” in this disclosure refers to entities such as companies, institutions, and associations. Employees refer to those individuals that are paid by the payroll system 22 of the organization, whether or not those individuals fit a strict legal definition of an employee. Billers are third parties, not including the organization or the employees, to which the employees may have financial obligations. The payroll system 22 of the organization may include one or more dashboards indicating various metrics pertaining to the employees' E₁-E_{N} usage of third party bill pay through the payroll system 22 and/or the application 24.

In this disclosure, an application 24 is incorporated into, or in communication with, the payroll system 22. The application 24 includes software, and may also include hardware. The payroll system 22 may also include a combination of hardware and software. The application 24 may be considered a software plug-in for the existing software of a payroll system 22. Alternatively, the application 24 is a stand-alone software application. The payroll system 22 and the application 24 may be embodied on and/or accessed by the first, second, and/or third computing devices 12, 14, 16. The application 24 is configured to cause the first, second, and/or third computing devices 12, 14, 16 to perform various methods and strategies, as discussed below.

In some embodiments, employees E₁-E_{N} and billers B₁-B_{N} can access the application 24 directly. In other embodiments, such as when the payroll system 22 incorporates the application 24 as a software plug-in, employees E₁-E_{N} have access to the functionality of the application through their payroll system 22. The employees E₁-E_{N} and billers B₁-B_{N} may see different interfaces when accessing the payroll system 22 and/or the application 24, as certain information may be confidential.

For many if not most employees E₁-E_{N}, the income received through their periodic paychecks represents a significant portion of their income, if not the sole source of their income. Further, employees E₁-E_{N} have become accustomed to not receiving physical paychecks, but instead have grown accustomed to receiving periodic direct deposits into their bank account(s) of choice and receiving a paystub, either physical or virtual, that details the deductions and withholdings for each pay period, such as those for taxes, healthcare, 401(k), etc. In this disclosure, the application 24 permits the employees E₁-E_{N} to choose to pay their bills owed to billers B₁-B_{N} through the payroll system 22. In other words, money owed to billers B₁-B_{N} is effectively paid directly to the billers B₁-B_{N} without being first transferred to a primary account of the employees E₁-E_{N}. Rather, the money owed to billers B₁-B_{N} is directed to a secondary account S of the employees E₁-E_{N}, each of which is owned by a respective employee E₁-E_{N}, and money from the secondary account S is directed to the billers B₁-B_{N}. The secondary account S is established solely for paying the billers B₁-B_{N}. The secondary account S is different than a primary account of the employees E₁-E_{N}, which is typically where a majority if not an entirety of the banking of the employees E₁-E_{N} is done. In an example of this disclosure, the sole purpose of the secondary account S is to assist in transferring funds from the payroll system 24 to the billers B₁-B_{N} via the secondary account S. When the employee initially enrolls in the bill pay functionality, the software application 24 requests that a financial institution establish the secondary account S in the name of the employee. The payroll system 22 would inform the employee of the need to establish a secondary account S and seek the consent of the employee in advance of requesting the account to be opened. Once the secondary account S has been created, all bills enrolled in third party bill pay through the payroll system 22 of that employee are paid using the same secondary account S. The payroll system 22 and the software application 24 direct funds to the billers B₁-B_{N} to pay the bills owed by the employees E₁-E_{N} via the secondary accounts S. In this manner, while the secondary accounts S are in the name of the employees E₁-E_{N}, the employees are not required to take any affirmative steps to transfer funds out of the secondary accounts S to the billers B₁-B_{N} to ensure the bills are paid.

While secondary accounts S are mentioned herein, this disclosure extends to other methods of transferring funds from the payroll system 22 to the billers B₁-B_{N}, including directly transferring funds from the payroll system 22 to the billers B₁-B_{N}. Alternatively, some billers B₁-B_{N} may have the option of creating their own page or portal within the application 24 permitting employees E₁-E_{N} to pay the billers directly (without using a secondary account S) via that page/portal, such as by using an electronic payment.

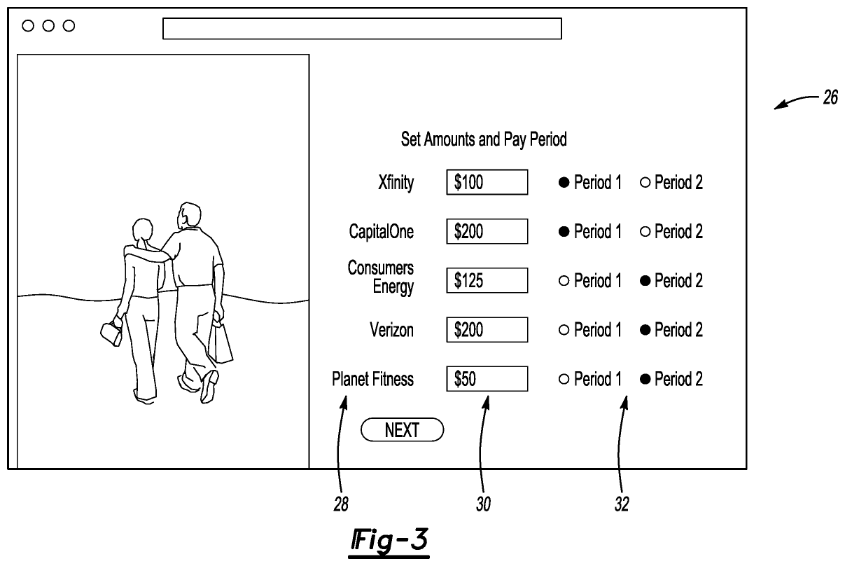

FIG. 3 illustrates an example interface 26 of the application 24 which is presented to employees E₁-E_{N} via the first or second computing device 12, 14. Using the interface 26, an employee (i.e., one of employees E₁-E_{N}) may choose to pay one or more of their bills via the payroll system 22.

The interface 26 includes three columns 28, 30, 32. The first column 28 includes a list of billers B₁-B_{N}. The employee may be able to select from a list of billers B₁-B_{N} that have agreed to permit their bills to be paid via the application 24. In this example, the employee has chosen to have five bills paid via the application 24. The billers B₁-B_{N} are Xfinity, which is an internet and/or cable provider, Capital One, which is a credit card company, Consumers Energy, which is a utilities company, Verizon, which is a cell phone company, and Planet Fitness, which is a gym. These billers B₁-B_{N} are exemplary. The billers B₁-B_{N} may include mortgage companies or creditors.

The second column 30 permits the employee to enter the amount to be paid to the biller B₁-B_{N} via the application 24. As the amount may vary, this amount may be provided periodically, such as every month, to the application 24 by the billers B₁-B_{N}. The amounts may be provided by the billers B₁-B_{N} via an application programming interface (API) link from the billers B₁-B_{N} to the application 24. The API link may automatically pull the bill amounts using personally identifiable information (PII) of the employees E₁-E_{N}. In the third column 32, the employee is able to select which pay period, within a particular month, for example, that they wish to have a particular amount withheld from their paycheck and directed to a particular biller B₁-B_{N}. The employees E₁-E_{N} may also select an option for paying a monthly bill over two pay periods, by making two partial payments per month, if permitted by the billers B₁-B_{N}. In this manner, the employee is able to manage their cashflow by evenly distributing their bill pay or paying them all at one, depending on the preference of the employee. In this example, the employee has chosen to have their Xfinity and Capital One bills paid out of their first paycheck of the month, and while having their bills from Consumers Energy, Verizon, and Planet Fitness, paid out of the second paycheck of the month.

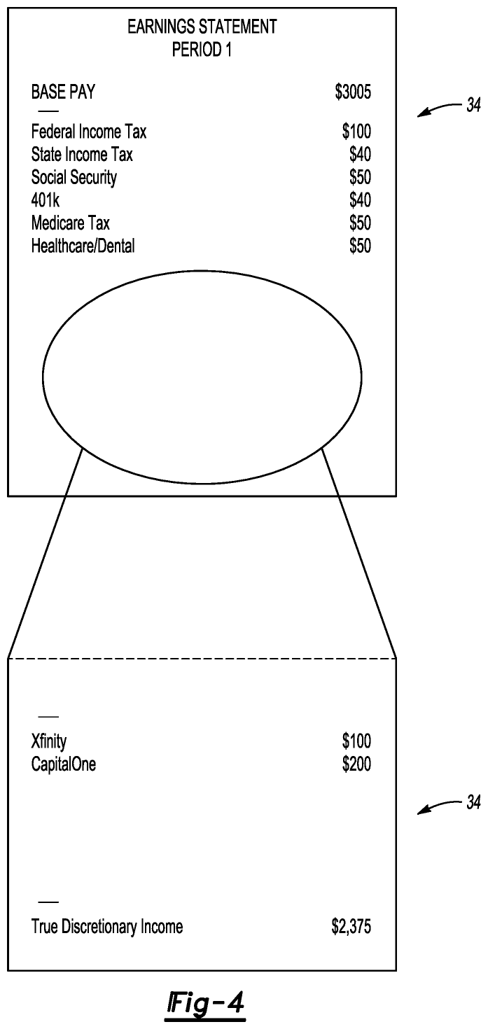

With reference to FIG. 4, another example interface 34 is shown. The example interface 34 is an interface of the application 24 and is presented to an employee via the first or second computing device 12, 14. The example interface 34 is an example paystub for period 1, following the example of FIG. 3. The paystub includes the employee's base pay, which is $3,005 in this example, and traditional withholdings such as taxes, 401(k), and healthcare, etc., which total $330 in this example. The paystub also includes the amounts paid to billers B₁-B_{N} during period 1. Following the example of FIG. 3, bills were paid to Xfinity and Capital One totaling $300. Thus, during period 1 the payroll system 22 paid $2,375 to the employee and transferred $300 to billers Xfinity and Capital One. The interface 34 thus presents to the employee relatively accurate representation of the discretionary income for period 1, which is $2,375. The accuracy of the discretionary income figure increases with a higher percentage of an employee's bills being paid through the application 24.

While not technically a “biller,” one of the billers B₁-B_{N} may be a personal savings account, including an actual savings account, brokerage account, 529 account, etc., of the employee. Thus, by treating personal savings as a “biller,” the employees E₁-E_{N} may use the application 24 to automate savings.

Another aspect of this disclosure includes providing the end users, which here are the employees E₁-E_{N}, with surveys regarding their experiences using the application 24, including surveys designed to determine whether the application 24 has improved their financial, physical, and/or mental health. The neural network 20 may receive and process the feedback from the surveys and recommend updates, upgrades, or changes to the application 24 over time based on the user feedback. The organization may have access to the results of the survey. The neural network 20 may also provide feedback and recommendations to the organization regarding their employees' overall health.

Another aspect of this disclosure includes providing benefits to the end users, who again are the employees E₁-E_{N}, for using the application 24 to pay their bills. Employers have an incentive in providing their employees E₁-E_{N} with such rewards because it improves the financial health of the workforce leading to a more productive workforce, and also helps with retention and recruitment efforts. The benefits could come in the form of monetary and/or non-monetary benefits, including incentives, rewards, etc., from the billers B₁-B_{N}, their employer, and/or the maker of the application 24. Another benefit may be the employers paying a bill for the employees E₁-E_{N} directly or indirectly by providing the employees E₁-E_{N} with funds corresponding to an amount of a bill of the employees E₁-E_{N}, such as by adding those funds to the appropriate secondary account S. The survey may ask end users questions to determine what types of benefits may be attractive to the end users. The neural network 20 may analyze that information and make recommendations to the employers and/or billers B₁-B_{N} to offer additional incentives to either retain users and/or attract new users to the application 24.

From a perspective of the employees E₁-E_{N}, their bills owed to the billers B 1-B_{N} are paid seamlessly with minimal effort on their part. In most cases, the majority if not all of the work involves enrolling in the application 24. One the back end, ensuring funds are transferred in the correct amounts and to the correct billers B₁-B_{N} may include coordination between the human resources department of the organization, the maker of the application 24, an intermediate bank that establishes secondary accounts S for the employees E₁-E_{N}, and the billers B₁-B_{N}. The application 24 may also contract with or use an intermediate bank or other financial institution capable of handling fund transfers. In an example, the application 24 may send files, such as comma-separated value (CSV) files, between the billers B₁-B_{N}, an intermediate bank, and the payroll system 22 including information regarding the bills that need to be paid to each biller B₁-B_{N} by each employee E₁-E_{N}. The application 24 may utilize batch processing to save on transaction costs. For instance, all bills paid by all employees E₁-E_{N} to a particular biller B₁-B_{N} are processed at the same time each month, regardless of when the employees E₁-E_{N} select that bill to be withheld from their paycheck (i.e., regardless of whether the employee selects period 1 or period 2 in FIG. 3).

In another example, a financial institution will be utilized solely for a depository function. In this case, fund transfers and bill payments are coordinated by a billing data provider. In another example, the payroll system 22 may connect using an API in order to have funds withdrawn.

In the example where the maker of the application 24 contracts with an intermediate bank or other financial institution to handle transferring of funds between the payroll system 22 and the billers B₁-B_{N}, the maker of the application 24 may open a bank account with the intermediate bank corresponding to each organization, and may further establish sub-accounts for each employee E₁-E_{N}. As funds are placed in these accounts, if only for a period of time, they may accumulate interest. The interest may be kept by the maker of the application 24 as additional income or transferred to the employees E₁-E_{N} as an incentive for using the application 24.

Another aspect of this disclosure relates to two or more employees E₁-E_{N} combining funds to pay a shared bill. For example, a husband and wife that either both work for the same employer or both work for employers that have payroll systems that subscribe to and/or use the application 24, can combine their funds to a pay a particular bill. For instance, one of the billers B₁-B_{N} may be a mortgage provider that provided a mortgage to the husband and wife. The husband and wife may divide their mortgage payment between them, either split evenly or at a different amounts, as selected by the users. The application 24 may then withhold a portion of the mortgage payment from the husband's paycheck and the remaining portion from the wife's paycheck. The payroll system 22 may then pay the mortgage to the mortgage provider. Again, in an example, the payroll system 22 first routes the funds to a secondary bank account, which may be owned by one or both of the husband and wife, and the funds are then directed to the mortgage company from the secondary bank account. This feature of combining funds to pay a shared bill may be used to pay bills other than a mortgage, and is not limited to use by a husband and wife. This feature may be particularly useful when a shared bill exceeds one employee's base pay for a particular pay period.

Another aspect of the neural network 20 relates to whether the employees E₁-E_{N} should incur additional monthly expenses. The neural network 20 is able to review the base pay and monthly expenses of all users, and the results of the end user surveys, to determine whether incurring another monthly expense will have adverse effects on the employee's physical, mental, or financial health. If the neural network 20 determines it is against an employee's interest to incur another expense, the neural network 20 may issue a warning prompt to the employee via an interface of the application 24. The employee may override the warning in some examples.

The neural network 20 may also suggest that a particular employee enroll certain of the employee's bills to be paid via the application 24 if, for example, the neural network 20 determines that the employee's physical, mental, or financial health would benefit from doing so. Again, this recommendation may be presented to the employee via an interface of the application 24, and the employee may either decide to accept or reject the recommendation of the neural network 20. The neural network 20 may also suggest that the employee use the application 24 to make certain payments for events or changes that may occur later in life, such as saving for purchasing a house, getting married, having a child, or reducing outstanding debt.

The application 24 could also pay billers B₁-B_{N} using a credit card of the employee E₁-E_{N}. In that scenario, the application 24 will still deduct the bill amounts from the employee's paycheck as described above, but will route the funds to the credit card company rather than the biller B₁-B_{N}, thus allowing the user to continue to gain credit card rewards while also ensuring the bills are paid in a timely manner.

In another aspect of this disclosure, employees E₁-E_{N} can compare themselves to other, similarly-situated end-users, including employees E₁-E_{N} or other users. The comparison is anonymized. The comparison may include one or more pieces of data, including the number of bills paid using the system, the amount of bills paid, etc. The comparison may deem users similarly-situated based on one or more of age, income, location, etc. The comparison may be presented on a dashboard visible by only an individual employee. Each employee would have a different dashboard. The dashboard may present information such as annual spend, categories of annual spend, credit score, etc., along with providing comparisons to similarly-situated users as to this information.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A method, comprising:
paying a bill owed by an employee to a third party biller using a payroll system of an organization by first directing funds from the payroll system to a secondary account of the employee and then directing funds from the secondary account to the third party biller.

2. The method as recited in claim 1, further comprising:
permitting the employee to select when the paying step occurs within a billing cycle, and wherein the paying step occurs at a time corresponding to the selection of the employee.

3. The method as recited in claim 2, wherein the permitting step includes permitting the employee to select to make a full payment of the bill during a first period in the billing cycle, a full payment of the bill during a second period in the billing cycle, or a partial payment of the bill during the first period and a partial payment of the bill during the second period in the billing cycle.

4. The method as recited in claim 2, wherein the permitting step includes presenting the employee with an interface on a computing device of the employee, wherein the interface includes inputs for the employee to make the selection.

5. The method as recited in claim 1, wherein the paying step includes paying a plurality of bills of the employee from the payroll system.

6. The method as recited in claim 5, further comprising:
presenting the employee with a discretionary income figure, wherein the discretionary income figure is a base pay of the employee less traditional withholdings and less the plurality of bills.

7. The method as recited in claim 1, wherein the secondary account is used solely for completing the paying step and is not a primary account of the employee.

8. The method as recited in claim 1, further comprising, using a neural network, suggesting that the employee pay another bill using the payroll system.

9. The method as recited in claim 1, wherein the payroll system communicates with a software application configured to at least partially perform the paying step.

10. The method as recited in claim 9, wherein the software application is a plug-in for payroll software.

11. The method as recited in claim 1, wherein the third party biller is a personal savings account of the employee.

12. The method as recited in claim 1, further comprising providing the employee with a reward for completing the paying step.

13. The method as recited in claim 12, wherein the reward is interest accumulated in the secondary account.

14. The method as recited in claim 1, wherein:
the bill is owed by a first employee and a second employee to the third party biller,
first funds are directed from the payroll system to the secondary account on behalf of the first employee,
second funds are directed from the payroll system to the secondary account on behalf of the second employee,
the combined first and second funds are directed from the secondary account to the third party biller.

15. The method as recited in claim 1, further comprising using a neural network to issue a warning to the employee if the employee is seeking to pay a bill that, in the determination of the neural network, will have an adverse influence on the physical, mental, or financial health of the employee.

16. The method as recited in claim 1, further comprising anonymously comparing the employee to similarly-situated users and disclosing the results of the comparison to the employee.

17. The method as recited in claim 1, wherein the secondary account is requested to be created by a software application when the employee initially begins using the payroll system to pay third party bills.

18. A system, comprising:
an application configured to run on a computing device and configured to cause the computing device to direct funds from a payroll system of an organization to pay a bill of an employee owed to a third party, wherein the funds are directed to the third party via a secondary account of the employee.

19. The system as recited in claim 18, wherein the application is configured to permit the employee to select when the funds are directed within a billing cycle.

20. The system as recited in claim 18, wherein the secondary account is used solely for completing the paying step and is not a primary account of the employee.
